(19) United States
(12) Patent Application Publication
(10) Pub. No.: US 2004/0179824 A1
(43) Pub. Date: Sep. 16, 2004

(54) Information playback apparatus and information playback method

(76) Inventors: Yasufumi Tsumagari, Yokohama-shi (JP); Hideki Mimura, Yokohama-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 10/740,617

(22) Filed: Dec. 22, 2003

(30) Foreign Application Priority Data
Dec. 27, 2002 (JP) 2002-381577

(51) Int. Cl. H04N 5/76; H04N 5/781

(52) U.S. Cl. 386/109; 386/125; 386/126

(57) ABSTRACT

An information playback apparatus according to an aspect of this invention has an image processing unit configured to process contents and image data contained in expansion information as needed on the basis of actual monitor information indicating an actual output destination of the contents and the expansion information, and a playback unit configured to play back the contents, and to play back image data, which is contained in the expansion information and has undergone the image process as needed, in synchronism with playback of the contents.

### CROSS-REFERENCE TO RELATED APPLICATIONS

This application is based upon and claims the benefit of priority from the prior Japanese Patent Application No. 2002-381577, filed Dec. 27, 2002, the entire contents of which are incorporated herein by reference.

### BACKGROUND OF THE INVENTION

1. Field of the Invention

The present invention relates to an information playback apparatus and information playback method for playing back contents stored in an information storage medium.

2. Description of the Related Art

In recent years, the standard for a read-only DVD (Digital Versatile Disk) has been specified, and playback apparatus that play back video/audio information stored in read-only DVDs are commercially available.

According to the read-only DVD standard, the read-only DVD stores presentation data which records actual video and audio data, and navigation data used to manage the presentation data. The presentation data contains video data, audio data, and sub-picture data, which are multiplexed according to the specification of a program stream (2048 bytes) specified by MPEG2. The navigation data describes PGCs (ProGram Chains) and Cells, which set a time configuration and order of video and audio data to be played back. With this navigation data, multi-angle, multi-story, and parental functions can be implemented.

As a prior art associated with the above technique, an image display apparatus which provides a service that integrates a DVD-Video title and HTML file has been disclosed in Jpn. Pat. Appln. KOKAI Publication No. 11-161663. This image display apparatus extracts a URL from a navigation pack in a video object unit, and establishes connection to the Internet based on the extracted URL, so as to display data in conjunction with a scene to be played back.

According to the read-only DVD standard, only an MPEG2 program stream recorded on a disk can be played back, and information other than the MPEG2 program stream recorded on the disk cannot be played back. That is, the expandability of DVD playback is poor.

Jpn. Pat. Appln. KOKAI Publication No. 11-161663 above has a problem in the contents display method. Various types of monitors as display means are available: a personal computer monitor, 4:3 TV monitor, and 16:9 TV monitor. Since these monitors have different pixel layouts, they display identical contents in different patterns. For example, contents which are created for the 4:3 TV monitor are displayed in a horizontally elongated pattern when they are displayed on the 16:9 TV monitor, and are displayed in a vertically elongated pattern when they are displayed on the personal computer monitor. Since the contents are formed as a combination of elements such as DVD data, moving picture data, still picture data, font data, and the like, it is difficult to create contents for each monitor.

### BRIEF SUMMARY OF THE INVENTION

An information playback apparatus according to an aspect of the present invention comprises a first acquisition unit configured to acquire contents from an information storage medium, a second acquisition unit configured to acquire expansion information from at least one of the information storage medium and an external apparatus via a communication line, an image processing unit configured to process the contents and image data contained in the expansion information as needed on the basis of actual monitor information indicating an actual output destination of the contents and the expansion information, and a playback unit configured to play back the contents, and to play back image data, which is contained in the expansion information and has undergone the image process as needed, in synchronism with playback of the contents.

An information playback method according to an aspect of the present invention comprises: acquiring expansion information from at least one of an information storage medium and an external apparatus via a communication line; processing contents acquired from the information storage medium and image data contained in the expansion information as needed on the basis of actual monitor information indicating an actual output destination of the contents and the expansion information; and playing back the contents, and playing back image data, which is contained in the expansion information and has undergone the image process as needed, in synchronism with playback of the contents.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 shows an example of the data structure of a DVD-Video disk;

FIG. 2 shows an example of the data structure of an enhanced DVD-Video disk;

FIG. 3 is a block diagram showing an example of a DVD playback apparatus (information playback apparatus);

FIG. 4 is a block diagram showing details of an element decoder and AV renderer adopted in the DVD playback apparatus shown in FIG. 3;

FIG. 5 shows an example of pixel conversion of contents for a PC monitor;

FIG. 6 is a view for explaining differences of the characteristics of a PC monitor, 4:3 TV monitor, and 16:9 TV monitor;

FIG. 7 is a flow chart showing an example of a contents display method assuming a case wherein contents respectively for a PC monitor, 4:3 TV monitor, and 16:9 TV monitor are prepared;

FIG. 8 is a flow chart showing an example of pixel conversion upon displaying contents for a 4:3 TV monitor on a 4:3 TV monitor, 16:9 TV monitor, and PC monitor;

FIG. 9 is a flow chart showing an example of pixel conversion upon displaying contents for a 16:9 TV monitor on a 4:3 TV monitor, 16:9 TV monitor, and PC monitor;

FIG. 10 is a flow chart showing an example of pixel conversion upon displaying contents for a PC monitor on a 4:3 TV monitor, 16:9 TV monitor, and PC monitor;

FIG. 11 shows an example upon displaying DVD-Video contents and ENAV contents on a 16:9 TV monitor;

FIG. 12 shows an example upon displaying DVD-Video contents and ENAV contents on a 4:3 TV monitor after LB conversion;

FIG. 13 shows an example upon displaying DVD-Video contents and ENAV contents on a 4:3 TV monitor after PS conversion;

FIG. 14 shows display example 1 upon displaying DVD-Video contents and ENAV contents on a 4:3 TV monitor after various kinds of conversion;

FIG. 15 shows display example 2 upon displaying DVD-Video contents and ENAV contents on a 4:3 TV monitor after various kinds of conversion;

FIG. 16 is a flow chart for explaining playback with an image process required to cope with various types of monitors;

FIG. 17 is a flow chart showing the flow upon playing back different contents in correspondence with the type of designated monitor; and

FIG. 18 shows an example of a CSS(Cascading-Style Sheet) file.

### DETAILED DESCRIPTION OF THE INVENTION

A preferred embodiment of the present invention will be described hereinafter with reference to the accompanying drawings.

The data structure of a disk which considers compatibility to the DVD-Video standard will be explained first.

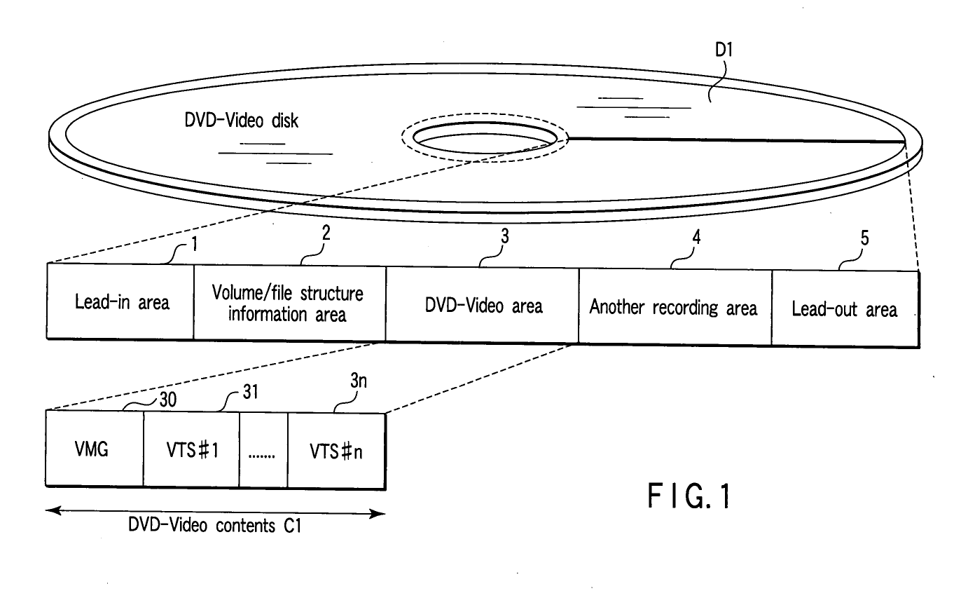

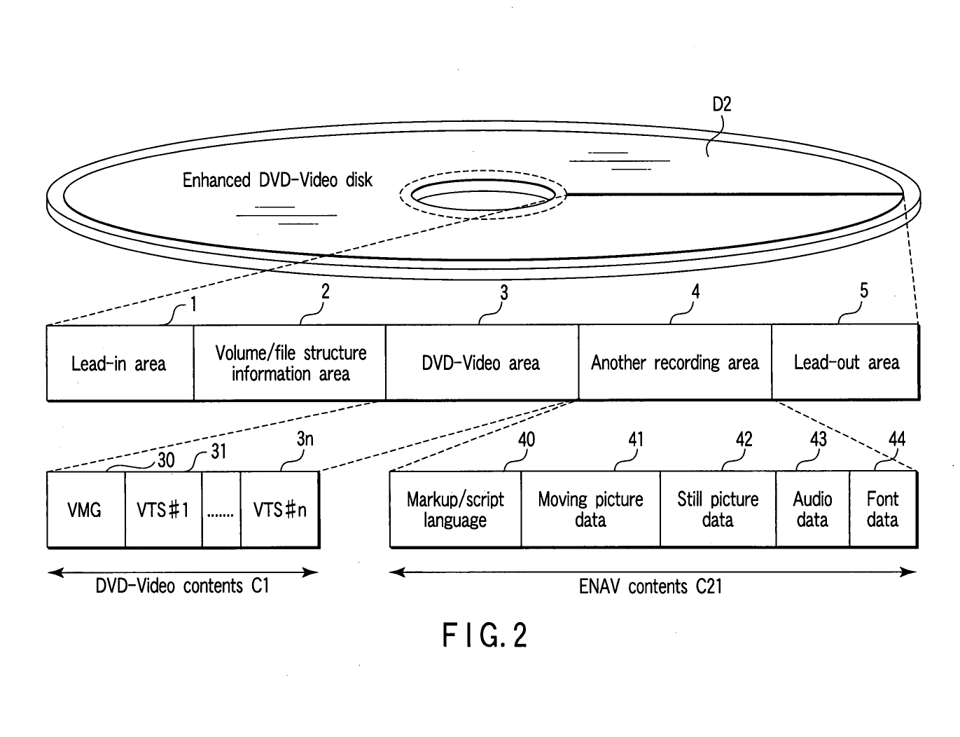

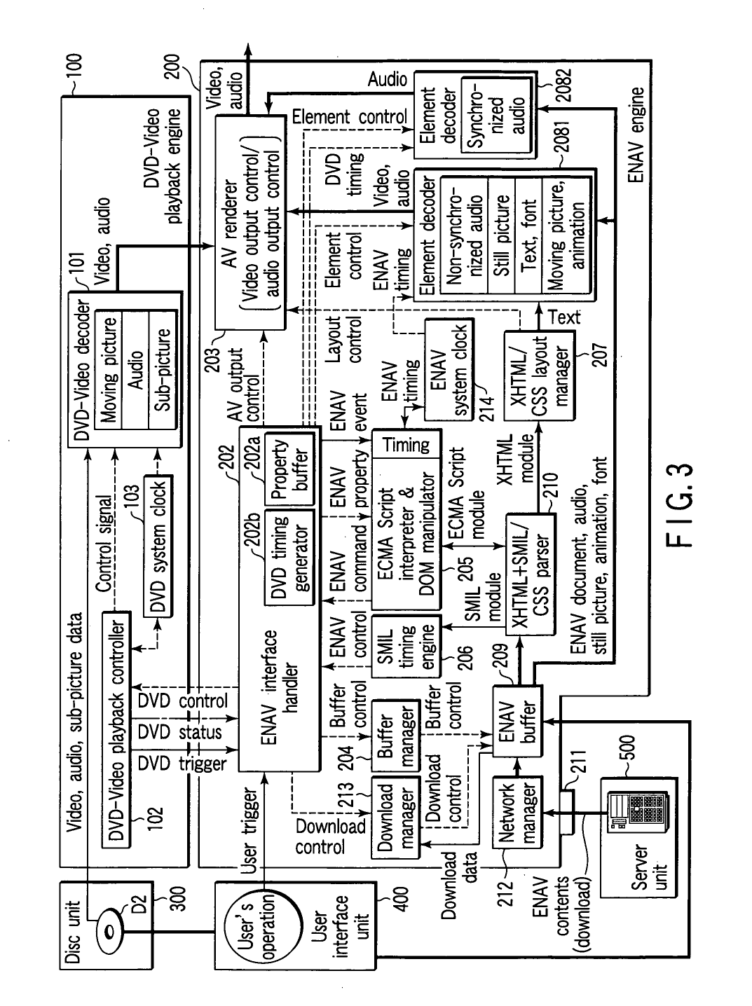

FIGS. 1 and 2 show examples of the data structures of DVD-Video disks which can be played back by a DVD-Video player shown in FIG. 3 (to be described later).

FIG. 1 shows an example of the data structure of a standard DVD-Video disk D1. A DVD-Video area 3 of the standard DVD-Video disk D1 stores DVD-Video contents C1 (having an MPEG2 program stream structure).

On the other hand, FIG. 2 shows the data structure of an enhanced DVD-Video disk D2. A DVD-Video area 3 of the enhanced DVD-Video disk D2 stores DVD-Video contents C1 (having an MPEG2 program stream structure) having the same data structure as the DVD-Video standard. Furthermore, another recording area 4 of the enhanced DVD-Video disk D2 stores enhanced navigation (to be abbreviated as ENAV hereinafter) contents C21 which allows a wide variety of playback of video contents. Note that the presence of the recording area 4 is also accepted in the DVD-Video standard.

The basic data structure of a DVD-Video disk will be explained below. The recording area of the DVD-Video disk includes a lead-in area 1, volume space, and lead-out area 5 in turn from its inner periphery. The volume space contains a volume/file structure information area 2, and DVD-Video area (DVD-Video zone) 3, and can also have another recording area (DVD other zone) 4 as an option.

The volume/file structure information area 2 is assigned for a UDF (Universal Disk Format) bridge. The volume of the UDF bridge format is recognized according to ISO/IEC13346 Part 2. A space that recognizes this volume consists of successive sectors, and starts from the first logical sector of the volume space in FIGS. 1 and 2. First 16 logical sectors are reserved for system use specified by IS09660. In order to assure compatibility to the conventional DVD-Video standard, the volume/file structure information area 2 with such contents is required.

The DVD-Video area 3 records management information called video manager VMG 30 and one or more video contents called video title sets VTS (VTS#1 to VTS#n). The VMG 30 is management information for all VTSs present in the DVD-Video area 3, and contains control data VMGI, VMG menu data VMGM_VOBS (option), and VMG backup data. Each VTS contains control data VTSI of that VTS, VTS menu data VTSM_VOBS (option), data VTSTT_VOBS of the contents (movie or the like) of that VTS (title), and VTSI backup data. To assure compatibility to the conventional DVD-Video standard, the DVD-Video area with such contents is also required.

A playback select menu or the like of each title (VTS#1 to VTS#n) is given in advance by a provider (the producer of a DVD video disk) using the VMG, and a playback chapter select menu, the playback order of recorded contents (cells), and the like in a specific title (e.g., VTS#1) are given in advance by the provider using the VTSI. Therefore, the viewer of the disk (the user of the DVD-Video player) can enjoy the recorded contents of that disk in accordance with menus of the VMG/VTSI prepared in advance by the provider and playback control information (program chain information PGCI) in the VTSI. However, with the DVD-Video standard, the viewer (user) cannot play back the contents (movie or music) of each VTS by a method different from the VMG/VTSI prepared by the provider.

The enhanced DVD-Video disk D2 shown in FIG. 2 is prepared for a mechanism that allows the user to play back the contents (movie or music) of each VTS by a method different from the VMG/VTSI prepared by the provider, and to play back while adding contents different from the VMG/VTSI prepared by the provider. The ENAV contents C21 contained in this disk D2 cannot be accessed by a DVD-Video player which is manufactured on the basis of the conventional DVD-Video standard (even if the ENAV contents can be accessed, their contents cannot be used). However, a DVD-Video player (player in FIG. 3 or the like) can access the ENAV contents C21, and can use their playback contents.

The ENAV contents C21 (C22) are configured to contain audio data, still picture data, font/text data, moving picture data, animation data, and the like, and also an ENAV document (described in a Markup/Script language) as information for controlling playback of these data. This playback control information describes, using a Markup language or Script language, playback methods (display method, playback order, playback switch sequence, selection of data to be played back, and the like) of the ENAV contents (consisting of audio, still picture, font/text, moving picture, animation, and the like) and/or the DVD-Video contents C1. For example, Markup languages such as HTML (Hyper Text Markup Language)/XHTML (extensible Hyper Text Markup Language), SMIL (Synchronized Multimedia Integration Language), and the like, Script languages such as an ECMA (European Computer Manufacturers Association) script, JavaScript, and the like, and so forth, may be used in combination.

Since the contents of the enhanced DVD-Video disk D2 in FIG. 2 except for the other recording area comply with the DVD-Video standard, video contents recorded on the DVD-Video area can be played back using an already prevalent DVD-Video player (i.e., this disk is compatible to the conventional DVD-Video disk D1).

The ENAV contents C21 recorded on the other recording area cannot be played back (or used) by the conventional DVD-Video player but can be played back and used by a DVD-Video player (FIG. 3) according to an embodiment of the present invention. Therefore, when the ENAV contents C21 (and also ENAV contents C22) are played back using the DVD-Video player according to an embodiment of the present invention, the user can enjoy not only the contents of the VMG/VTSI prepared in advance by the provider but also a variety of video playback features.

FIG. 3 shows an example of a DVD-Video player used to play back an enhanced DVD-Video disk (FIG. 2) according to the embodiment of the present invention. This DVD-Video player plays back and processes recorded contents (DVD-Video contents C1 and/or ENAV contents C21) from the enhanced DVD-Video disk D2 (FIG. 2) which is compatible to the DVD-Video standard, and downloads and processes ENAV contents C22 via a communication line such as the Internet or the like. Note that the ENAV contents C21 are first expansion information, and the ENAV contents C22 are second expansion information.

Note that ENAV contents C21 and C22 are one type of expansion information.

The DVD-Video player shown in FIG. 3 comprises a DVD-Video playback engine 100, ENAV engine 200, disk unit 300, and user interface unit 400. The DVD-Video playback engine 100 plays back and processes an MPEG2 program stream (DVD-Video contents C1) recorded on the disk D2. The ENAV engine 200 plays back and processes the ENAV contents C21 and C22. The disk unit 300 reads out the DVD-Video contents C1 and/or ENAV contents C21 recorded on the disk D2. The user interface unit 400 transmits inputs (user's operations) by the user of the player as user trigger.

The ENAV engine 200 comprises an Internet connection unit 211. The Internet connection unit 211 serves as a communication means used to establish connection to a communication line such as the Internet or the like. Furthermore, the ENAV engine 200 comprises an ENAV buffer unit (preload/download buffer) 209, XHTML+SMIL/CSS parser 210, XHTML/CSS layout manager 207, ECMA Script interpreter & DOM manipulator 205, SMIL timing engine 206, ENAV interface handler 202, element decoders 2081 and 2082, AV renderer 203, buffer manager 204, download manager 213, network manager 212, and ENAV system clock 214.

In the block arrangement shown in FIG. 3, a DVD-Video playback controller 102, a DVD-Video decoder 101, a DVD system clock 103, the ENAV interface handler 202, the XHTML+SMIL/CSS parser 210, the ECMA Script interpreter & DOM manipulator 205, the SMIL timing engine 206, the XHTML/CSS layout manager 207, the AV renderer 203, the element decoders 2081 and 2082, the buffer manager 204, the download manager 213, the network manager 212, the ENAV system clock 214, and the like can be implemented by a microcomputer (and/or hardware logic) which serves as functions of the respective blocks by an installed program (firmware; not shown). A work area used upon executing this firmware can be assured on a semiconductor memory (and a hard disk as needed; not shown) in the respective blocks.

The DVD-Video playback engine 100 is a device for playing back the DVD-Video contents C1 based on the existing DVD-Video standard, and includes the DVD-Video decoder 101 which decodes the DVD-Video contents C1 loaded by the disk unit 300, the DVD-Video playback controller 102 which makes playback control of the DVD-Video contents C1, and the DVD system clock 103 that determines the decode and output timings in the DVD-Video decoder.

The DVD-Video decoder 101 has a function of decoding video data, audio data, and sub-picture data based on the existing DVD-Video standard, and outputting the decoded video data (mixed data of the aforementioned video and sub-picture data) and audio data, respectively. With this function, the DVD-Video playback engine 100 has the same function as that of a playback engine of a normal DVD-Video player, which is manufactured based on the existing DVD-Video standard. That is, the player shown in FIG. 3 can play back video data, audio data, and the like of an MPEG2 program stream as in a normal DVD-Video player, and can play back an existing DVD-Video disk (complying with the conventional DVD-Video standard) D1.

In addition, the DVD-Video playback controller 102 can also control playback of the DVD-Video contents C1 in accordance with a “DVD control” signal output from the ENAV engine 200. More specifically, if an arbitrary event (e.g., menu call or title jump) has occurred in the DVD-Video playback engine 100 in a DVD-Video playback mode, the DVD-Video playback controller 102 can output a “DVD trigger” signal indicating the playback status of the DVD-Video contents C1 to the ENAV engine 200. In this case (simultaneously with output of the DVD trigger signal or at an appropriate timing before and after the output), the DVD-Video playback controller 102 can output a “DVD status” signal indicating property information (e.g., an audio language, sub-picture subtitle language, playback operation, playback position, various kinds of time information, disk contents, and the like set in the player) of the DVD-Video player to the ENAV engine 200.

The ENAV interface handler 202 receives “user trigger” signals corresponding to user's operations (menu call, title jump, play start, play stop, play pause, etc.) from the user interface unit 400. The ENAV interface handler 202 then transfers the received “user trigger” signals as corresponding ENAV events to the ECMA Script interpreter & DOM manipulator 205. For example, the ENAV document makes the following instructions in response to the ENAV events.

1. Issue an ENAV command corresponding to a user's operation. That is, the same command as the user's operation is transferred to the DVD-Video playback engine 100 as DVD control.

2. Issue an ENAV command different from a user's operation. That is, the user's operation is replaced by another operation in accordance with the instruction of the ENAV document.

3. Ignore the user trigger. That is, the user event is inhibited since, for example, a DVD-Video playback process that is not designed by the contents provider may be made.

Note that the contents of the user trigger signal transmitted to the ENAV interface handler 202 may be transmitted to the AV renderer 203 as an “AV output control” signal. As a result, for example, when the user has changed the contents or window size or has shifted its display position using a cursor key of a remote controller (not shown), a user trigger signal is output to the AV renderer 203 as a corresponding AV output control signal. In addition, when a user event indicating switching between a video/audio output from the DVD-Video playback engine 100 and that from the ENAV engine 200 is sent to the AV renderer 203, the video/audio output can be switched in response to user's operation.

The ENAV interface handler 202 exchanges a “DVD status” signal, “DVD trigger” signal, and/or “DVD control” signal with the DVD-Video playback controller 102, or exchanges a “user trigger” signal with the user interface unit 400. Furthermore, the ENAV interface handler 202 exchanges an “ENAV event”, “ENAV property”, “ENAV command”, and “ENAV control” signal with the ECMA Script interpreter & DOM manipulator 205 and SMIL timing engine 206. More specifically, the ENAV interface handler 202 executes the following processes.

1. The handler 202 transmits a “DVD trigger” signal which is received from the DVD-Video playback engine 100 and indicates the operation of the DVD-Video playback engine 100, or a “user trigger” which is received from the user interface unit 400 and indicates the user's operation to the ECMA Script interpreter & DOM manipulator 205 and SMIL timing engine 206 as an “ENAV event”.

2. The handler 202 transmits a “DVD status” signal which is received from the DVD-Video playback engine 100 and indicates the playback status of the DVD-Video playback engine 100 to the ECMA Script interpreter & DOM manipulator 205 and SMIL timing engine 206 as an “ENAV property”. At this time, DVD status information is saved in a property buffer 202a of the ENAV interface handler 202 as needed.

3. The handler 202 transmits an “ENAV control” signal from the SMIL timing engine 206 to the DVD-Video playback engine 100 as a “DVD control” signal.

4. The handler 202 outputs a “DVD control” signal used to control playback of the DVD-Video playback engine 100 to the DVD-Video playback engine 100, an “AV output control” signal used to switch video and audio data to the AV renderer 203, a “buffer control” signal used to load/erase the contents of the buffer to the buffer manager 204, a “download control” signal used to download ENAV contents stored in the server unit to the download manager 213, and an “element control” signal that instructs to decode ENAV elements to the element decoders 2081 and 2082, in accordance with the contents of an “ENAV command” signal from the ECMA Script Interpreter & DOM manipulator 205.

5. The handler 202 measures information of the DVD system clock in the DVD-Video playback engine 100 using its DVD timing generator 202b, and transfers it as a “DVD timing” signal to the element decoder 2082. That is, the element decoder 2082 can decode ENAV elements in synchronism with the system clocks of the DVD-Video playback engine 100.

As described above, the ENAV interface handler 202 has a function of parsing and interpreting ENAV contents, and then converting control signals and the like between the DVD-Video playback engine 100 and ENAV engine 200.

The ENAV interface handler 202 is configured to exchange a first signal and to exchange a second signal on the basis of the contents which are parsed by the XHTML+SMIL/CSS parser 210 and are interpreted by the ECMA Script interpreter & DOM manipulator 205 and SMIL timing engine 206, or a user trigger from an input device. In other words, the ENAV interface handler 202 controls the output states of video and audio signals by the AV renderer 203 on the basis of at least one of the first signal exchanged with the DVD-Video playback controller 102, and the second signal exchanged with the ECMA Script interpreter & DOM manipulator 205 and SMIL timing engine 206. The first signal pertains to the playback status of the DVD-Video disk D2, and corresponds to the “DVD control” signal, “DVD trigger” signal, “DVD status” signal, and the like. The second signal pertains to the contents of the ENAV contents, and corresponds to the “ENAV event” signal, “ENAV command” signal, “ENAV property” signal, “ENAV control” signal, and the like.

Note that the ENAV interface handler 202 is configured to execute processes corresponding to user triggers in accordance with the ENAV document. The AV renderer 203 is configured to mix video/audio data generated by the element decoder 2081 with video/audio data played back by the DVD-Video playback engine 100, and to output the mixed data on the basis of the execution result of the process corresponding to the user trigger signal. Or the AV renderer 203 is configured to select one of video/audio data generated by the element decoder 2081 and video/audio data played back by the DVD-Video playback engine 100, and to output the selected video/audio data on the basis of the execution result of an ENAV command in the ENAV interface handler 202.

Generally speaking, the XHTML+SMIL/CSS parser 210 parses an ENAV document indicating playback control information, which is contained in the ENAV contents C21 acquired from the DVD-Video disk D2 or the ENAV contents C22 acquired from the Internet or the like. The ENAV document is made up of a combination of Markup languages such as HTML/XHTML, SMIL, and the like, and Script languages such as ECMA Script, JavaScript, and the like, as described above. The XHTML+SMIL/CSS parser 210 has a function of transmitting an ECMA Script module to the ECMA Script interpreter & DOM manipulator 205, SMIL module to the SMIL timing engine 206, and XHTML module to the XHTML/CSS layout manager 207 in accordance with the parsing result.

The ECMA Script interpreter & DOM manipulator 205 interprets the aforementioned ECMA Script module and follows its instruction. That is, the ECMA Script interpreter & DOM manipulator 205 has a function of issuing an “ENAV command” signal to the ENAV interface handler 202 in correspondence with an “ENAV event” signal sent from the ENAV interface handler 202 or an “ENAV property” signal read from the property buffer of the ENAV interface handler 202.

At this time, the ECMA Script interpreter & DOM manipulator 205 issues an “ENAV command” signal to the DVD-Video playback engine 100 or issues an “element control” signal to the element decoder 2081 in accordance with the time measured by the ENAV system clock 214, thus controlling the DVD-Video playback engine 100 or decoding ENAV elements (audio, still picture, text/font, moving picture/animation).

The SMIL timing engine 206 interprets the aforementioned SMIL module and follows its instruction. That is, the SMIL timing engine 206 has a function of issuing an “ENAV control” signal to the ENAV interface handler 202 or element decoder 208 in correspondence with an “ENAV event” signal sent from the ENAV interface handler 202 or an “ENAV property” signal read from the property buffer of the ENAV interface handler 202 in accordance with the ENAV System clock 214. With this function, control of the DVD-Video playback engine 100 and playback of video data (moving picture, still picture, animation) and audio data can be achieved at a desired timing.

The XHTML/CSS layout manager 207 interprets the aforementioned XHTML module and follows its instruction. That is, the XHTML/CSS layout manager 207 outputs a “layout control” signal to the AV renderer. The “layout control” signal contains information associated with the size and position of a video window to be output (this information often contains information associated with a display time such as display start, end, or continue), and information associated with the level of audio data to be output (this information often contains information associated with an output time such as output start, end, or continue). Also, text information to be displayed, which is contained in the XHTML module, is sent to the element decoder 208, and is decoded and displayed using desired font data.

Practical methods of parsing and interpreting Markup and Script languages can adopt the same methods as parsing/interpretation in state-of-the-art techniques such as HTML/XHTML, SMIL, and the like or ECMA Script, JavaScript, and the like (the hardware used is the microcomputer that has been mentioned at the beginning of the description of FIG. 3). Note that commands and variables described in Scripts are different since objects to be controlled are different. The ENAV document used upon practicing the present invention uses unique commands and variables associated with playback of the DVD-Video disk D2 and/or the ENAV contents C21 or C22. For example, a command that switches the playback contents of the DVD-Video disk D2 or the ENAV contents C21 or C22 in response to a given event is unique to a Markup or Script language in the ENAV document.

As another example of commands and variables unique to a Markup or Script language in the ENAV document, those which are used to change the video size from the DVD-Video playback engine 100 and/or ENAV engine 200 and to change the layout of that video data are available. A change in video size is designated using a size change command and a variable that designates the size after change. A change in video layout is designated by a display position change command and a variable that designates the coordinate position or the like after change. When objects to be displayed overlap on the screen, a variable that designates depth ordering is added. Also, commands and variables used to change the audio level from the DVD-Video playback engine 100 and/or ENAV engine 200 or to select an audio language to be used are available. A change in audio level is designated by an audio level change command and a variable that designates an audio level after change. An audio language to be used is selected by an audio language change command and a variable that designates the type of language after change. Furthermore, commands and variables used to control user trigger from the user interface unit 400.

On the basis of the commands/variables of the Markup and Script languages in the ENAV document, as exemplified above, a “layout control” signal is sent from the XHTML/CSS layout manager (some functions are often implemented by the SMIL timing engine 206) to the AV renderer 203. The “layout control” signal controls the layout on the screen, size, output timing, and output time of video data to be displayed on, e.g., an external monitor device or the like (not shown), and/or the tone-volume, output timing, and output time of audio data to be played back from an external loudspeaker (not shown).

The element decoder 208 decodes ENAV contents data such as audio data, still picture data (include background picture data), text/font data, moving picture data, animation data, and the like contained in the ENAV contents C21 or C22. That is, the element decoder 208 includes an audio decoder, still picture decoder, text/font decoder, and animation/moving picture decoder in correspondence with objects to be decoded. For example, audio data in the ENAV contents, which is encoded by, e.g., MPEG, AC-3, or DTS is decoded by the audio decoder and is converted into non-compressed audio data. Still picture data or background picture data, which is encoded by JPEG, GIF, or PNG, is decoded by the still picture decoder, and is converted into non-compressed image data. Likewise, moving picture/animation data, which is encoded by MPEG2, MPEG4, Macromedia Flash, or SVG (Scalable Vector Graphics) is decoded by the moving picture/animation decoder, and is converted into non-compressed moving picture data. Text data contained in the ENAV contents is decoded by the text/font decoder using font data contained in the ENAV contents, and is converted into text image data which can be superimposed on a moving or still picture. Video/audio data, which contains these decoded audio data, image data, animation/moving picture data, and text image data as needed, is sent from the element decoder 208 to the AV renderer 203.

These ENAV contents are decoded in accordance with an instruction of an “element control” signal from the ENAV interface handler 202. Also, ENAV contents (e.g., audio commentary data, audio after-recording data) which are synchronous with the DVD-Video contents are decoded in synchronism with a “DVD timing” signal from the ENAV interface handler 202. Furthermore, ENAV contents which are asynchronous with the DVD-Video contents are decoded in synchronism with an “ENAV timing” signal from the ENAV system clock 214.

The AV renderer 203 has a function of controlling a video/output output. More specifically, the AV renderer 203 controls, e.g., the video display position and size (often including the display timing and display time together), and the audio level (often including the output timing and output time together) in accordance with the “layout control” signal output from the XHTML/CSS layout manager 207. Also, the AV renderer 203 performs pixel conversion of a video to be displayed in accordance with the type of the designated monitor and/or the type of the video to be displayed. The video/output outputs to be controlled are those from the DVD-Video playback engine 100 and element decoder 2081. Furthermore, the AV renderer 203 has a function of controlling mixing and switching of the DVD-Video contents C1 and ENAV contents C21 or C22 in accordance with an “AV output control” signal output from the ENAV interface handler 202.

Note that the ENAV engine 200 in the DVD-Video player in FIG. 3 comprises an interface for sending the ENAV document in the ENAV contents C21 read from the DVD-Video disk D2 to the XHTML+SMIL/CSS parser 210 via the ENAV buffer unit 209, and an interface for sending data (audio data, still picture data, text/font data, moving picture data, and the like) in the read ENAV contents C21 to the element decoder 208 via the ENAV buffer unit 209. These interfaces form an interface (first interface) independent from the Internet connection unit 211 in FIG. 3.

The DVD-Video player in FIG. 3 comprises an interface for receiving the ENAV contents C22 from a communication line such as the Internet or the like, and sending the ENAV document in the received ENAV contents C22 to the XHTML+SMIL/CSS parser 210 via the ENAV buffer unit 209, and an interface for sending data (audio data, still picture data, text/font data, moving picture data, and the like) in the received ENAV contents C22 to the element decoder 208 via the ENAV buffer unit 209. These interfaces form the Internet connection unit (second interface) shown in FIG. 3.

The ENAV buffer unit 209 comprises buffers used to store the ENAV contents C22 downloaded from the server unit 500, and to store the ENAV contents C21 loaded from the enhanced DVD-Video disk D2 by the disk unit 300.

The ENAV buffer unit 209 reads the ENAV contents C22 on an external server (server unit 500) under the control of the buffer manager 204 based on the ENAVE documents (Markup/Script language), and downloads the ENAV contents C22 via the Internet connection unit 211.

The ENAV buffer unit 209 loads the ENAV contents C21 recorded on the enhanced DVD-Video disk D2 under the control of the buffer manager 204 based on the ENAV document (Markup/Script language). At this time, if the disk unit 300 is a device that can access the disk at high speed, it can read out the ENAV contents C21 from the enhanced DVD-Video disk D2 while playing back the DVD-Video contents C1, i.e., reading out DVD-Video data from the enhanced DVD-Video disk D2. If the disk unit 300 is not a device that can make high-speed access, or if the playback operation of the DVD-Video contents C1 is to be perfectly guaranteed, playback of the DVD-Video contents C1 must not be interrupted. In such case, the ENAV contents C21 are read out from the enhanced DVD-Video disk D2 and are stored in a preload unit (not shown) of the ENAV buffer unit 209 in advance prior to the beginning of playback. In this way, since the ENAV contents C21 are read out from the preload unit simultaneously when the DVD-Video contents C1 are read out from the enhanced DVD-Video disk D2, the load on the disk unit 300 can be reduced. Hence, the DVD-Video contents C1 and ENAV contents can be simultaneously played back without interrupting playback of the DVD-Video contents C1.

In this way, when the ENAV contents C22 downloaded from the server unit 500 are stored in the ENAV buffer unit 209 in the same manner as the ENAV contents C21 recorded on the enhanced DVD-Video disk D2, the DVD-Video contents C1 and ENAV contents C22 can be simultaneously read out and played back.

The ENAV buffer unit 209 has a limited storage capacity. That is, the data size of ENAV contents C21 or C22 that can be stored in the ENAV buffer unit 209 is limited. For this reason, it is possible to erase ENAV contents C21 or C22 with low necessity and to save those with high necessity under the control of the buffer manager 204 (buffer control). Such save control and erase control may be automatically executed by the ENAV buffer unit 209.

The buffer manager 204 can send the following instructions as “buffer control” to the ENAV buffer unit 209 in accordance with an instruction of the ENAV document.

load a specific file or a part of file from a server (download)

load a specific file or a part of file from a disk (preload)

erase a specific file or a part of file from a buffer

The download manager 213 has a function of acquiring download data from the enhanced DVD disk D2 of the disk unit 300 or the server unit 500 in accordance with an instruction of the ENAV document, parsing the download data, downloading required ENAV contents from the server unit 500 (download control), and holding the downloaded contents in the ENAV buffer unit 209.

For example, when the download data is made up of a file name to be downloaded, location, file size, and contents type, the download manager 213 loads download data on the disk or that on the server at a timing designated by the ENAV document. The download manager 213 instructs to download data in the order they are described in the file (or all data at the same time) (download control).

For example, when the download data is made up of a file name to be downloaded, location, file size, contents type, playback start time, and playback end time, the download manager 213 loads the ENAV document, and also download data on the disk or that on the server designated by the ENAV document at the same time. The download manager 213 loads ENAV contents with high priority of playback until the ENAV buffer becomes full of data with reference to the file size and playback start time of the download data, and starts playback. Then, the download manager 213 erases ENAV contents that have been played back from the ENAV buffer with reference to the playback end time, and loads new ENAV contents.

The network manager 212 controls the operation of the Internet connection unit 211. That is, when the ENAV document instructs connection/disconnection to/from the network as an ENAV command, the network manager 212 switches connection/disconnection of the Internet connection unit 211.

The building components of the ENAV engine in FIG. 3 can also be summarized as follows. That is, the ENAV engine comprises:

XHTML+SMIL/CSS Parser 210

The XHTML+SMIL/CSS parser 210 parses the contents of the ENAV documents.

ECMA Script Interpreter & DOM Manipulator 205, SMIL Timing Engine 206, XHTML/CSS Layout Manager 207

The ECMA Script Interpreter & DOM manipulator 205, SMIL timing engine 206, and XHTML/CSS layout manager 207 respectively interpret the parsed modules.

ENAV Interface Handler 202

The ENAV interface handler 202 handles control signals from the ECMA Script Interpreter & DOM manipulator 205 and SMIL timing engine 206, and those from the DVD-Video playback controller 102.

Element Decoder 208

The element decoder 208 generates video/audio data corresponding to audio data, still picture data, text/font data, moving picture data, and the like contained in the ENAV contents C21 or C22 synchronized system clock of the DVD playback engine and ENAV engine.

AV Renderer 203

The AV renderer 203 outputs data obtained by mixing video/audio data generated by the element decoder 208 to that played back by the DVD-Video playback engine 100 on the basis of the execution result of the ENAV command in the ENAV interface handler 202. Or the AV handler 203 selectively outputs one of video/audio data generated by the element decoder 208 and that played back by the DVD-Video playback engine 100 on the basis of the execution result of the ENAV command in the ENAV interface handler 202.

ENAV Buffer Unit 209

The ENAV buffer unit 209 temporarily stores the ENAV contents C22 acquired from the disk unit 300 or from the server unit 500 via the Internet connection unit 211.

Download Manager 213

The download manager 213 downloads ENAV contents from the server unit to the ENAV buffer on the basis of download data.

Network Manager 212

The network manager 212 controls connection/disconnection to/from the network and the like in accordance with an instruction of the ENAV document.

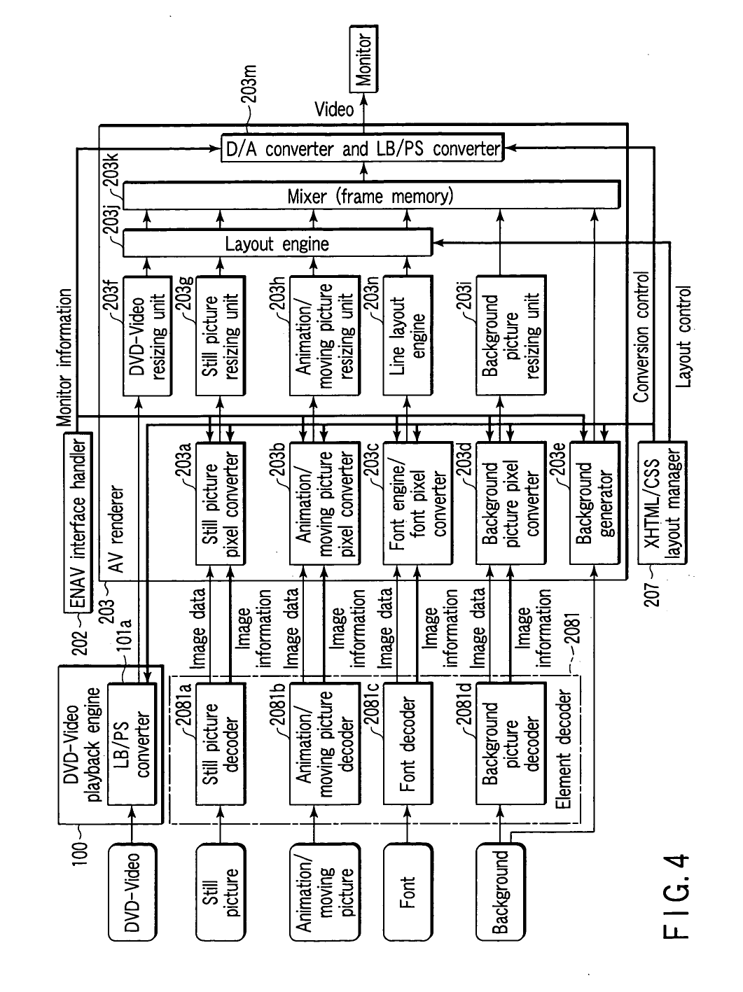

FIG. 4 is a schematic view showing a pixel conversion function and related functions.

The DVD-Video contents are decoded by the decoder 101 of the DVD-Video playback engine 100, and undergo one of “letter box conversion (LB conversion)”, “pan scan conversion (PS conversion)”, and “no conversion” in an LB/PS converter 101a in accordance with an instruction (conversion control) of the XHTML/CSS layout manager 207 based on the ENAV document (LB/PS conversion). Furthermore, the converted contents are converted to a designated size by a DVD-Video resizing unit 203f in accordance with an instruction (conversion control) of the XHTML/CSS layout manager 207 (reduction, enlargement, equal magnification). The layout of the converted contents on a monitor is determined by a layout engine 203j in accordance with an instruction (layout control) of the XHTML/CSS layout manager 207 based on the ENAV document, and the converted contents are then mixed with other ENAV elements (still picture, animation/moving picture, font, background) by a mixer 203k.

At this time, switching of “LB conversion”, “PS conversion”, and “no conversion” by the XHTML/CSS layout manager 207 may be made by user's operations as long as the description of the ENAV document permits. That is, a switching instruction of the conversion is transferred as DVD control to the DVD-Video playback controller 102 of the DVD-Video playback engine 100 in response to a user trigger from the user interface unit 400.

Still picture data and animation/moving picture data are respectively decoded by a still picture decoder 2081a and animation/moving picture decoder 2081b of the element decoder 2081. The converted data then undergo pixel conversion in a still picture converter 203a or animation/moving picture pixel converter 203b in the AV renderer 203 on the basis of an instruction (conversion control) of the XHTML/CSS layout manager 207, ‘information of a monitor designated as an output destination (monitor information)’ which can be acquired from the ENAV interface handler, and the information (image information) from the still picture decoder 2081a and animation/moving picture decoder 2081b (still picture pixel conversion and animation/moving picture pixel conversion).

The monitor information indicates one of “4:3 TV monitor”, “16:9 TV monitor”, and “PC monitor” as the monitor designated as an output destination. In other words, the monitor information is information (actual monitor information) indicating that an actual monitor as an output destination is a PC monitor, 4:3 TV monitor, or 16:9 TV monitor. Also, the image information indicates on which of monitors, i.e., one of “4:3 TV monitor”, “16:9 TV monitor”, “PC monitor”, and “no designation” the decoded still picture data and animation/moving picture data are designed to be displayed. In other words, the image information is information (optimal monitor information) which indicates an optimal monitor (one of a PC monitor, 4:3 TV monitor, and 16:9 TV monitor) used to output.

For example, the aforementioned still picture data and animation/moving picture data have a field that records information indicating on which of monitors these data are designed to be displayed. The respective decoders decode data themselves, and also read this monitor information. The decoders send the read monitor information to the pixel converters 203a, 203b, 202c, and 202d. Furthermore, the ENAV document describes “PS conversion”, “LB conversion”, or “no conversion” when image information (optimal monitor information) and monitor information (actual monitor information) have different contents for given still picture data or animation/moving picture data. This information is supplied to the pixel converters 203a, 203b, 202c, and 202d as conversion control.

Moreover, the image information (optimal monitor information) may be recorded as, e.g., the file name of still picture data or animation/moving picture data in place of internal data of the still picture data or animation/moving picture data.

For example, when the monitor information (actual monitor information) of given still picture data or animation/moving picture data indicates “4:3 TV monitor” and the image information (optimal monitor information) also indicates “4:3 TV monitor”, since information of image data matches that of the monitor, conversion is unconditionally skipped. When the monitor information (actual monitor information) indicates “16:9 TV monitor”, and the image information (optimal monitor information) indicates “4:3 TV monitor”, since information of image data is different from that of the monitor, designated conversion (one of PS conversion, LB conversion, and no conversion) is made in accordance with the description of the ENAV document.

As another example, the ENAV document describes information indicating on which of monitors still picture data and animation/moving picture data are designed to be displayed in some cases. That is, even when still picture data or animation/moving picture data does not record any image information, or even when the pixel converters 203a, 203b, 202c, and 202d do not acquire any image information from the decoders 2081a, 2081b, and 2081c, one of conversion processes can be made in accordance with the monitor information (actual monitor information) and the description of the ENAV document.

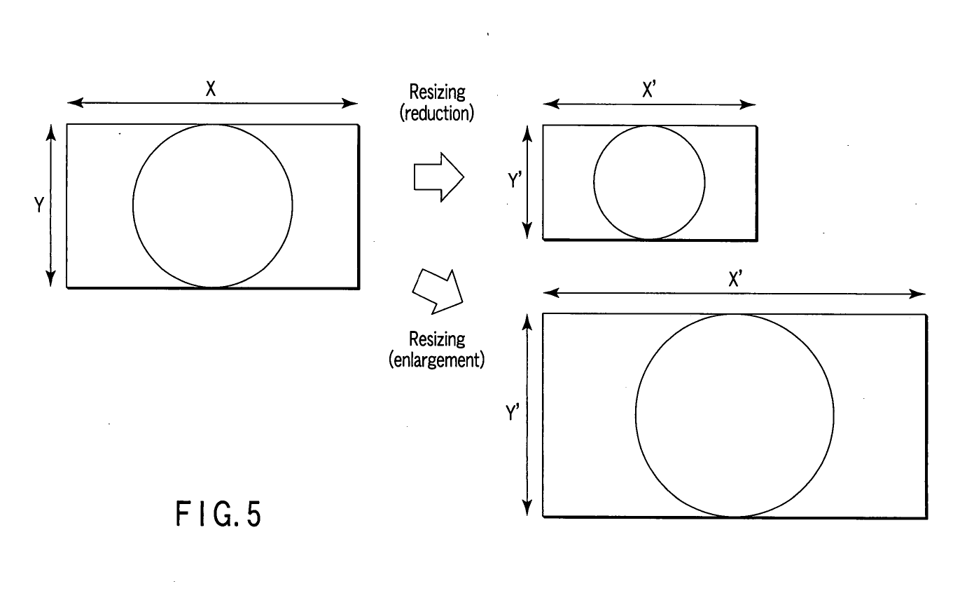

The still picture data and animation/moving picture data that have undergone pixel conversion are converted to a designated size (reduction, enlargement, equal magnification, or the like), as shown in FIG. 5, by a still picture resizing unit 203g or animation/moving picture resizing unit 203h, in accordance with an instruction (conversion control) of the XHTML/CSS layout manager 207 (still picture resizing, animation/moving picture resizing).

DVD-Video data is resized by the DVD-Video resizing unit 203f as needed. Still picture data is resized by the still picture resizing unit 203g as needed. Also, animation/moving picture data is resized by the animation/moving picture resizing unit 203h as needed. Furthermore, background picture data is resized by a background picture resizing unit 203i as needed.

The order of pixel conversion and resizing may be reversed. That is, after data may be resized to a designated size, they may undergo designated pixel conversion. Upon executing pixel conversion and resizing, image quality deteriorates in each conversion process. Hence, the order of pixel conversion and resizing may be changed depending on the conversion method and resizing method, thus suppressing such deterioration. For example, when enlargement (resizing) is done after LB conversion (pixel conversion), errors produced by LB conversion are enlarged by enlargement. In this case, when LB conversion (pixel conversion) is done after enlargement (resizing), errors can be prevented from being enlarged.

Finally, the resized still picture data and animation/moving picture data are laid out by the layout engine 203j at locations designated by the ENAV document (layout control from the XHTML/CSS layout manager 207). Then, these data are mixed with the DVD-Video data and other ENAV elements (font, background) on a frame memory of the mixer 203k.

Text data of the ENAV document is decoded by a font decoder 2081c of the element decoder 2081 using font data, and is rasterized by a font engine/font pixel converter 202c. At the same time, the font engine/font pixel converter 202c executes pixel conversion (font pixel conversion) as needed on the basis of ‘information of a monitor designated as an output destination (monitor information)’ which can be acquired from the ENAV interface handler, and information (image information) from the font decoder 2081c, in accordance with an instruction (conversion control) of the XHTML/CSS layout manager 207. Note that the conversion control, monitor information (actual monitor information), and image information (optimal monitor information) are the same as those of the aforementioned still picture data and animation/moving picture data.

Since font data corresponding to sizes to be displayed are pre-stored, they need not be resized if the XHTML/CSS layout manager 207 uses required font data. However, if the types of font sizes stored as font data are not sufficient, font data of a given size must be converted (enlarged or reduced) into that of the designated size.

Furthermore, the rasterized font data undergoes corrections of the character spacing and width in a line layout engine 203n. This is a function of adjusting a character string or the number of characters to be laid out per line/column designated by the ENAV document to fall within the range, as designated by the ENAV document. For example, when a character string to be laid out in one line extends across two lines, it is laid out to fall within one line by reducing the character spacing or width. Conversely, when a character string to be laid out over the entire line cannot fill up that line, it is laid out over the entire line by increasing the character spacing or width.

Finally, the font data is laid out by the layout engine 203j at the location designated by the ENAV document (layout control). Then, the font data is mixed with the DVD-Video data and other ENAV elements (still picture, animation/moving picture, background) on the frame memory of the mixer 203k.

As for background picture data, there are two cases, i.e., a case wherein still picture data recorded on the enhanced DVD disk or server unit 500 is used and a case wherein the AV renderer 203 generates a designated background picture.

In the former case, still picture data which is designated by the ENAV document as a background picture is decoded by a background picture decoder 2081d in the element decoder 2081. Furthermore, the decoded background picture data undergoes pixel conversion (background picture pixel conversion) by a background picture pixel converter 202d in the AV renderer 203 on the basis of an instruction (conversion control) from the XHTML/CSS layout manager 207, ‘information of a monitor designated as an output destination (monitor information)’ which can be acquired from the ENAV interface handler, and the information (image information) from the background picture decoder. Note that the conversion control, monitor information (actual monitor information), and image information (optimal monitor information) are the same as those of the aforementioned still picture data and animation/moving picture data.

Furthermore, the background picture data that has undergone pixel conversion is converted into a designated size (reduction, enlargement, equal magnification, or the like) by the background picture resizing unit 203i in accordance with an instruction (conversion control) of the XHTML/CSS layout manager 207 (background picture resizing).

The resized background picture data is rasterized on a background frame memory (not shown) by a method designated by the ENAV document. For example, as the rasterizing method, a method of laying out one background picture data at the designated location, and a method of laying out a plurality of identical background picture data side by side are available.

Finally, the data on the background frame memory is rasterized on the frame memory of the mixer 203k. At this time, the EX-OR of the data on the background frame memory and the data on the frame memory of the mixer 203k, which include the DVD-Video data and other ENAV elements (still picture, animation/moving picture, font), is added to the frame memory of the mixer 203k. That is, the data on the background frame memory is laid out on the frame memory of the mixer 203k with respect to pixels on the frame memory of the mixer 203k where none of still picture data, animation/moving picture data, and font data are laid out. In this way, the still picture data, animation/moving picture data, and font data are laid out in preference to (above) the background picture data.

In the latter case, a background generator 203e of the AV renderer 203 generates data used as a background on the basis of information such as “color”, “pattern”, and the like designated by the ENAV document. The generated-background data is rasterized on the background frame memory, and is mixed with the DVD-Video data and other ENAV elements on the frame memory of the mixer 203k in the same manner as in the former case.

The priority of overlapping among DVD-Video data, ENAV elements including background data is defined by Markup document such as HTML/XHTML and CSS. In other words, transparency (so-called alpha-blending) of each element (that is, DVD-Video, ENAV elements including background data) is described in the Markup document.

The DVD-Video contents and ENAV contents rasterized on the frame memory of the mixer 203k are D/A-converted by a D/A converter & LB/PS converter 203m. The converted contents then undergo a “PS conversion”, “LB conversion”, or “no conversion” process in accordance with an instruction (conversion control) of the XHTML/CSS layout manager 207, and are output to the connected monitor (D/A conversion & LB/PS conversion). At this time, switching of “LB conversion”, “PS conversion”, and “no conversion” by the XHTML/CSS layout manager 207 may be made by user's operations as long as the description of the ENAV document permits. That is, a switching instruction of the conversion is transferred as AV output control to the AV renderer 203 in response to a user trigger from the user interface unit 400.

The order of D/A conversion and LB/PS conversion may be reversed. That is, after the data on the frame memory of the mixer 203k undergoes LB/PS conversion and the converted data is rasterized on a new frame memory, D/A conversion is executed. The former method, i.e., the method of executing LB/PS conversion after D/A conversion can be implemented using a small frame memory size while suppressing image quality deterioration in the two conversion process. On the other hand, the latter method of LB/PS conversion requires the frame memory, but can improve the degree of freedom in LB/PS conversion.

The effects obtained upon executing pixel conversion will be explained below.

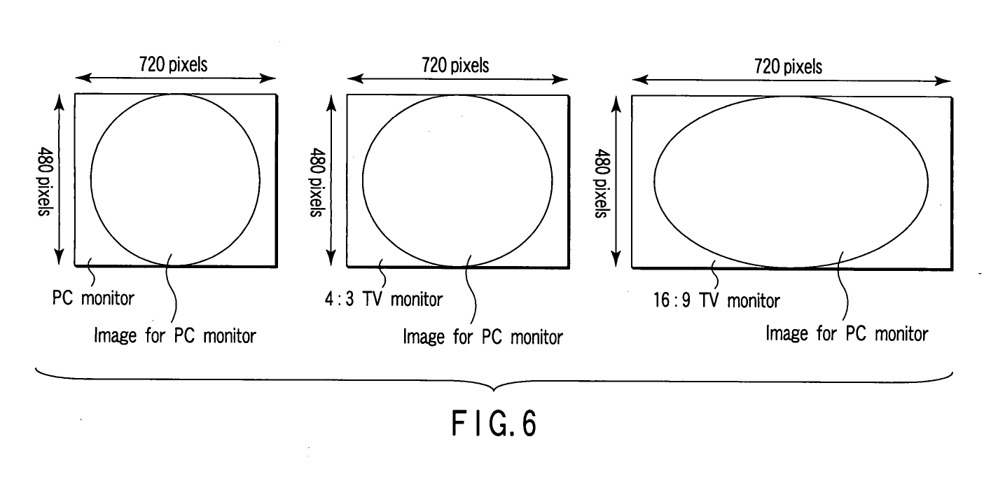

As shown in FIG. 6, there are several types of monitors, i.e., a PC monitor, 4:3 TV monitor, and 16:9 TV monitor. These monitors have different pixel layouts. On the PC monitor, vertical and horizontal pixels are arranged uniformly (Square Pixel). By contrast, the 4:3 TV monitor has an aspect ratio of about 1:1.2, and the 16:9 TV monitor has an aspect ratio of about 1:1.6 (Rectangular Pixel). That is, an original image, which is a perfect circle on the PC monitor, appears as a horizontally elongated oval on the 4:3 TV monitor, and as a further horizontally elongated oval on the 16:9 TV monitor.

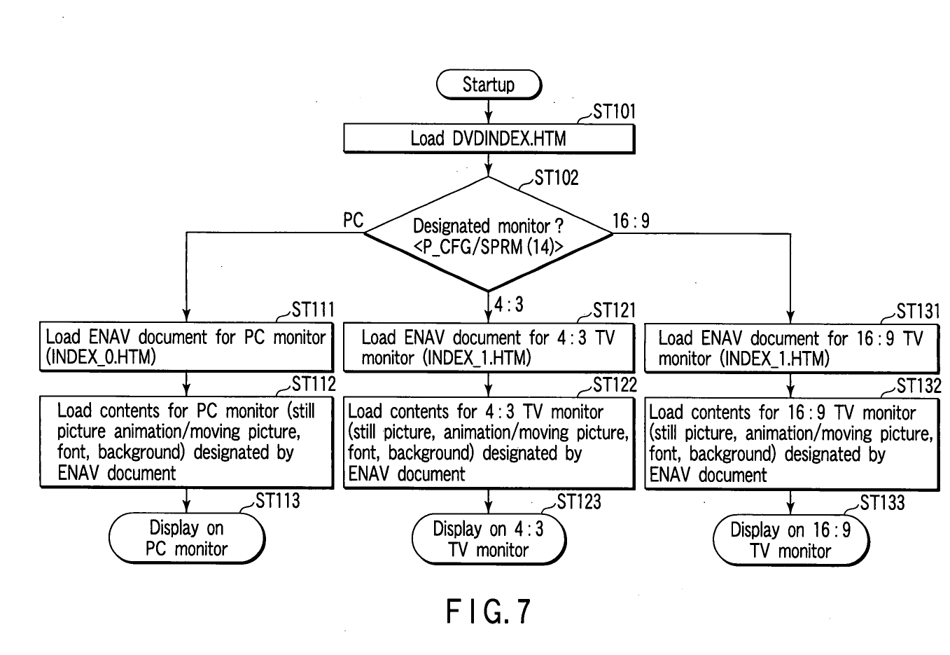

Hence, in order to display appropriate videos on the respective monitors, contents must be prepared for these monitors. FIG. 7 is a flow chart showing the flow upon playing back different contents in correspondence with the type of designated monitor.

Upon reception of a startup instruction, the ENAV engine 200 loads an ENAV document (DVDINDEX.HTM) which is stored on the enhanced DVD disk and is required to start up (ST101). For example, DVDINDEX.HTM describes an instruction for loading a predetermined file after information of the output monitor of user's choice (actual monitor information), i.e., a default aspect ratio (SPRM(14)) in a video player configuration (P_CFG) (ST102). If the output monitor information is “00b” which indicates “4:3 TV monitor”, “INDEX_{—}1.HTM” is loaded (ST121). If the output monitor information is “11b” which indicates “16:9 TV monitor”, “INDEX_{—}2.HTM” is loaded (ST131). If the output monitor information is “10b” which indicates “PC monitor”, “INDEX_{—}0.HTM” is loaded (ST111). “INDEX_{—}1.HTM” as the ENAV document for the 4:3 TV monitor describes a link to ENAV contents (still picture, animation/moving picture, font, background) for the 4:3 TV monitor. Also, this ENAV document describes an output method of DVD-Video contents onto the 4:3 TV monitor (current display mode of the video player configuration: “normal or wide (no conversion)”, “pan scan (PS conversion)”, “letter box (LB conversion)”. The ENAV contents for the 4:3 TV monitor are loaded according to this document (ST122), and can be displayed on the 4:3 TV monitor (ST123).

Likewise, “INDEX_{—}2.HTM” describes a link to ENAV contents for the 16:9 TV monitor, and an instruction for DVD-Video contents. The ENAV contents for the 16:9 TV monitor are loaded according to this document (ST132), and can be displayed on the 16:9 TV monitor (ST133).

Also, “INDEX_{—}3.HTM” describes a link to ENAV contents for the PC monitor, and an instruction for DVD-Video contents. The ENAV contents for the PC monitor are loaded according to this document (ST112), and can be displayed on the PC monitor (ST113).

In this example, since all ENAV contents are created for corresponding output monitors, no pixel conversion is required. That is, “no conversion” is designated in still picture pixel conversion, animation/moving picture pixel conversion, font pixel conversion, and background picture pixel conversion.

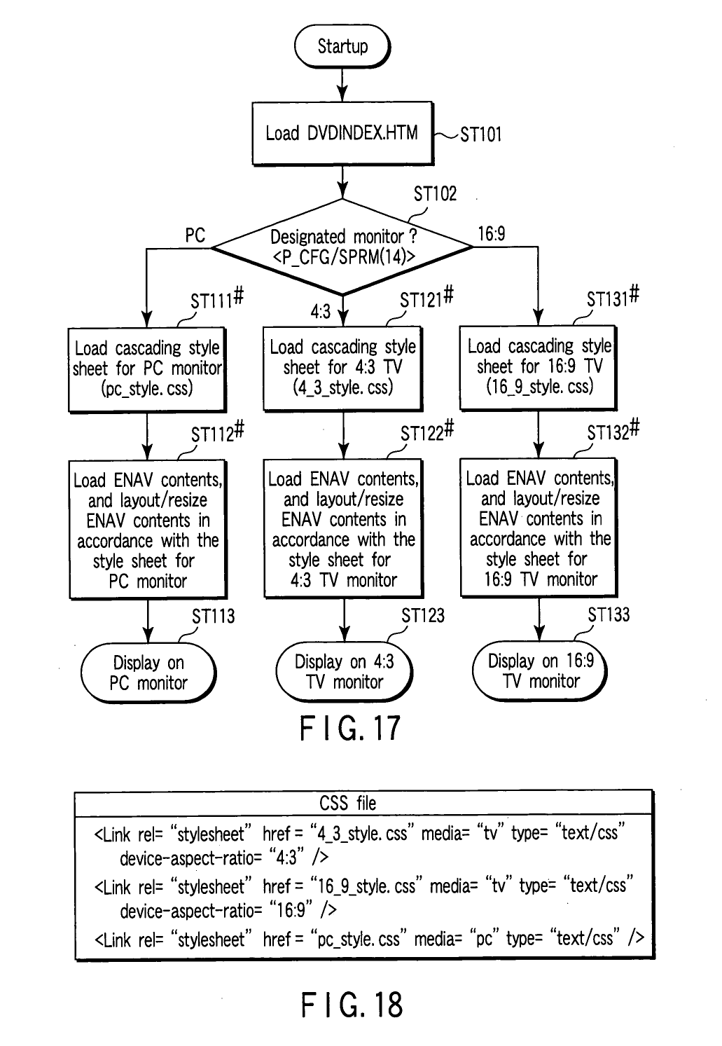

As another example, in order to display appropriate videos on the respective monitors, CSS (cascading style sheet) which is information to control the position and the size of contents must be prepared for these monitors. FIG. 17 is a flow chart showing the flow upon playing back different contents in correspondence with the type of designated monitor.

Upon reception of a startup instruction, the ENAV engine 200 loads an ENAV document (DVDINDEX.HTM) which is stored on the enhanced DVD disk and is required to start up (ST101). For example, DVDINDEX.HTM describes an instruction for loading a CSS(Cascading Style Sheet) file (as described in FIG. 18) after information of the output monitor of user's choice (actual monitor information), i.e., a default aspect ratio (SPRM(14)) in a video player configuration (P_CFG) (ST102). If the output monitor information is “00b” which indicates “4:3 TV monitor”, “4_{—}3_style.css” is loaded (ST121#). If the output monitor information is “11b” which indicates “16:9 TV monitor”, “16_{—}9_style.css” is loaded (ST131#). If the output monitor information is “10b” which indicates “PC monitor”, “pc_style.css” is loaded (ST111#). “4_{—}3_style.css” as the style sheet for the 4:3 TV monitor describes position information (ordinate and abscissa) and size information (vertical/horizontal length or scale-up/down ratio) to layout ENAV contents (still picture, animation/moving picture, font, background) for the 4:3 TV monitor. Also, this style sheet describes an output method of DVD-Video contents onto the 4:3 TV monitor (current display mode of the video player configuration: “normal or wide (no conversion)”, “pan scan (PS conversion)”, “letter box (LB conversion)”.

Likewise, “16_{—}9_style.css” describes position/size information to layout ENAV contents for the 16:9 TV monitor, and an instruction for DVD-Video contents.

Also, “pc_style.css” describes position/size information to layout ENAV contents for the PC monitor, and an instruction for DVD-Video contents.

However, preparing contents in correspondence with respective monitors imposes a heavy load on contents creation of the contents provider, and the ENAV contents occupy larger disk and buffer sizes. Hence, a method of sharing contents (still picture, animation/moving picture, font, background picture) for a given monitor with other monitors will be described below. That is, if contents for a given monitor are not prepared, display is made using available contents for another monitor. A method of executing image processes such as pixel conversion, resizing, and the like as needed (in accordance with an instruction of the ENAV document or the setup of the playback apparatus) at that time will be described below.

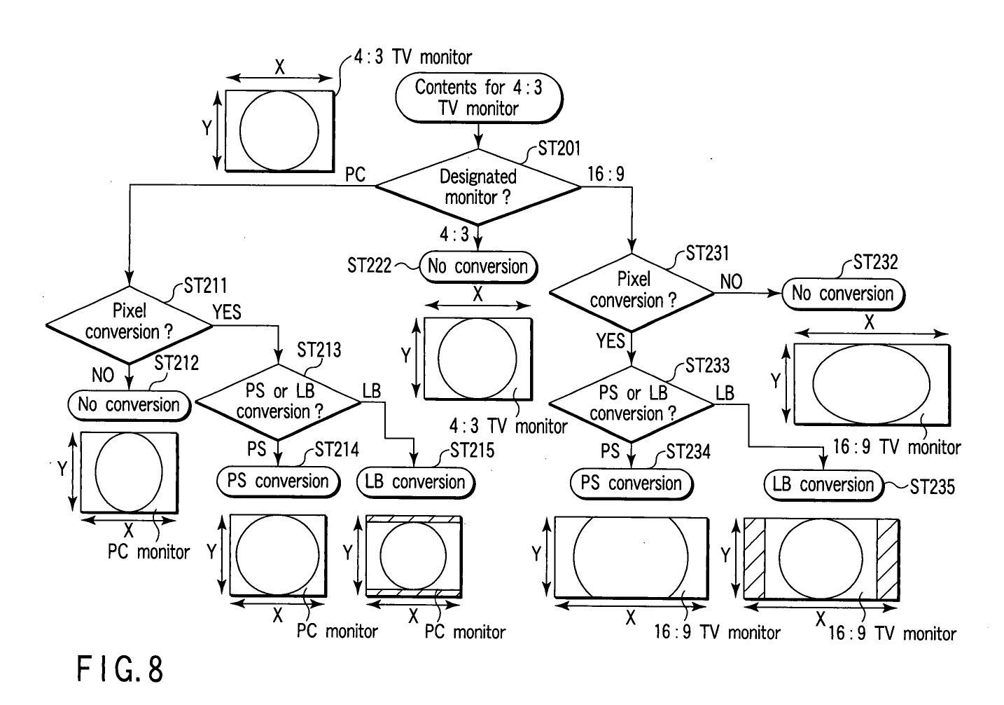

FIG. 8 shows an example of pixel conversion executed when contents for the 4:3 TV monitor are to be displayed on the 4:3 TV monitor, 16:9 TV monitor, and PC monitor.

The respective pixel converters (still picture pixel converter 203a, animation/moving picture pixel converter 203b, font pixel converter 202c, background picture pixel converter 202d) receive image data and image information (indicating one of “4:3 TV monitor”, “16:9 TV monitor”, and “PC monitor” for which that picture is designed) from the corresponding decoders (still picture decoder 2081a, animation/moving picture decoder 2081b, font decoder 2081c, background picture decoder 2081d), and confirm that the image data are designed for the 4:3 TV monitor. Note that information indicating a monitor on which the image data is to be displayed can be described in an ENAV document in place of image data itself.

The designated monitor is determined with reference to the current display mode of the video player configuration (P_CFG) (ST201). That is, “monitor information” which is transferred from the ENAV interface to each pixel converter is referred to. At this time, if the designated monitor is a 4:3 TV monitor, since the monitor on which the contents are to be displayed matches the monitor which is designated to display, no pixel conversion is required (ST222).

If the designated monitor is a 16:9 TV monitor, it is checked based on the description of the ENAV document, i.e., conversion control sent from the XHTML/CSS layout manager 207 to the respective pixel converters if pixel conversion is to be executed (ST231). If no pixel conversion is to be executed, (ST231, NO), the contents are output without any conversion (ST232). In this case, contents are displayed to be horizontally elongated compared to the intended ones. If pixel conversion is to-be executed (ST231, YES), LB or PS conversion is executed in accordance with the description of the ENAV document (conversion control from the XHTML/CSS layout manager 207) (ST233, ST234, ST235). As a result of LB conversion in this case, non-display areas are formed on the right and left ends of the display area. Also, as a result of PS conversion in this case, the upper and lower portions of the original contents are not displayed.

If the designated monitor is a PC monitor, it is checked based on the description of the ENAV document, i.e., conversion control sent from the XHTML/CSS layout manager 207 to the respective pixel converters if pixel conversion is to be executed (ST211). If no pixel conversion is to be executed, (ST211, NO), the contents are output without any conversion (ST212). In this case, contents are displayed to be slightly vertically elongated compared to the intended ones. If pixel conversion is to be executed (ST211, YES), LB or PS conversion is executed in accordance with the description of the ENAV document (conversion control from the XHTML/CSS layout manager 207) (ST213, ST214, ST215). As a result of LB conversion in this case, non-display areas are formed on the upper and lower ends of the display area. Also, as a result of PS conversion in this case, the right and left end portions of the original contents are not displayed.

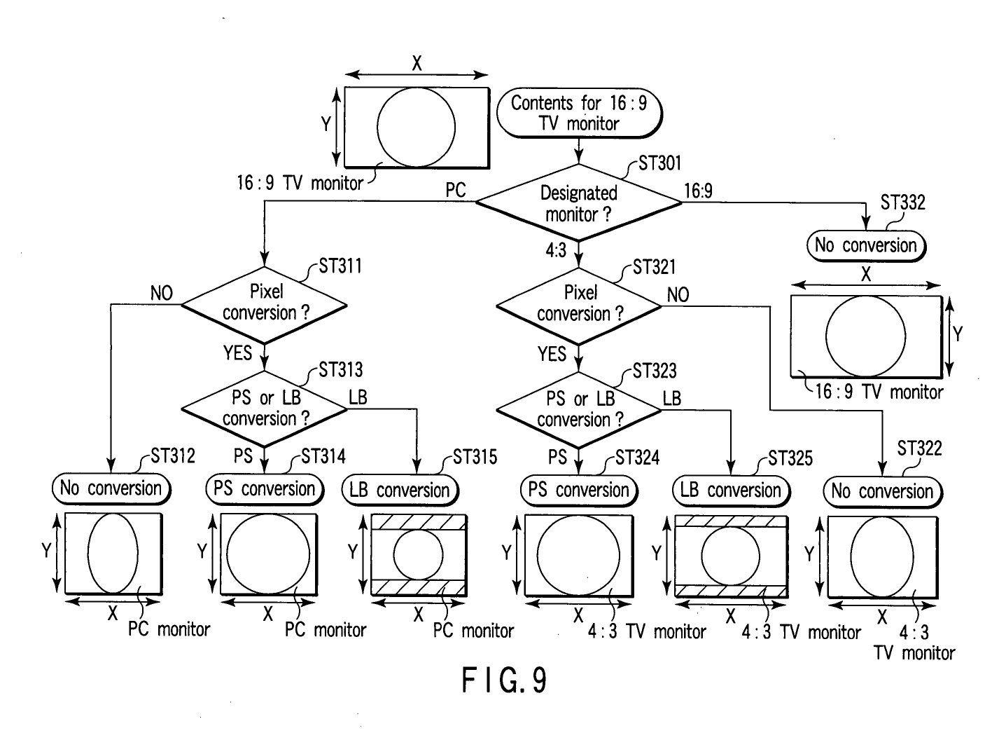

FIG. 9 shows an example of pixel conversion executed when contents for the 16:9 TV monitor are to be displayed on the 4:3 TV monitor, 16:9 TV monitor, and PC monitor.

The respective pixel converters (still picture pixel converter 203a, animation/moving picture pixel converter 203b, font pixel converter 202c, background picture pixel converter 202d) receive image data and image information (indicating one of “4:3 TV monitor”, “16:9 TV monitor”, and “PC monitor” for which that picture is designed) from the corresponding decoders (still picture decoder 2081a, animation/moving picture decoder 2081b, font decoder 2081c, background picture decoder 2081d), and recognize that the image data are designed for the 16:9 TV monitor. Note that information indicating a monitor on which the image data is to be displayed can be described in an ENAV document in place of image data itself.

The designated monitor is determined with reference to the current display mode of the video player configuration (P_CFG) (ST301). That is, “monitor information” which is transferred from the ENAV interface to each pixel converter is referred to. At this time, if the designated monitor is a 16:9 TV monitor, since the monitor on which the contents are to be displayed matches the monitor which is designated to display, no pixel conversion is required (ST332).

If the designated monitor is a 4:3 TV monitor, it is checked based on the description of the ENAV document, i.e., conversion control sent from the XHTML/CSS layout manager 207 to the respective pixel converters if pixel conversion is to be executed (ST321). If no pixel conversion is to be executed, (ST321, NO), the contents are output without any conversion (ST322). In this case, contents are displayed to be vertically elongated compared to the intended ones. If pixel conversion is to be executed (ST321, YES), LB or PS conversion is executed in accordance with the description of the ENAV document (conversion control from the XHTML/CSS layout manager 207) (ST323, ST324, ST325). As a result of LB conversion in this case, non-display areas are formed on the upper and lower ends of the display area. Also, as a result of PS conversion in this case, the right and left end portions of the original contents are not displayed.

If the designated monitor is a PC monitor, it is checked based on the description of the ENAV document, i.e., conversion control sent from the XHTML/CSS layout manager 207 to the respective pixel converters if pixel conversion is to be executed (ST311). If no pixel conversion is to be executed, (ST311, NO), the contents are output without any conversion (ST312). In this case, contents are displayed to be slightly vertically elongated compared to the intended ones. If pixel conversion is to be executed (ST311, YES), LB or PS conversion is executed in accordance with the description of the ENAV document (conversion control from the XHTML/CSS layout manager 207) (ST313, ST314, ST315). As a result of LB conversion in this case, non-display areas are formed on the upper and lower ends of the display area. Also, as a result of PS conversion in this case, the right and left end portions of the original contents are not displayed.

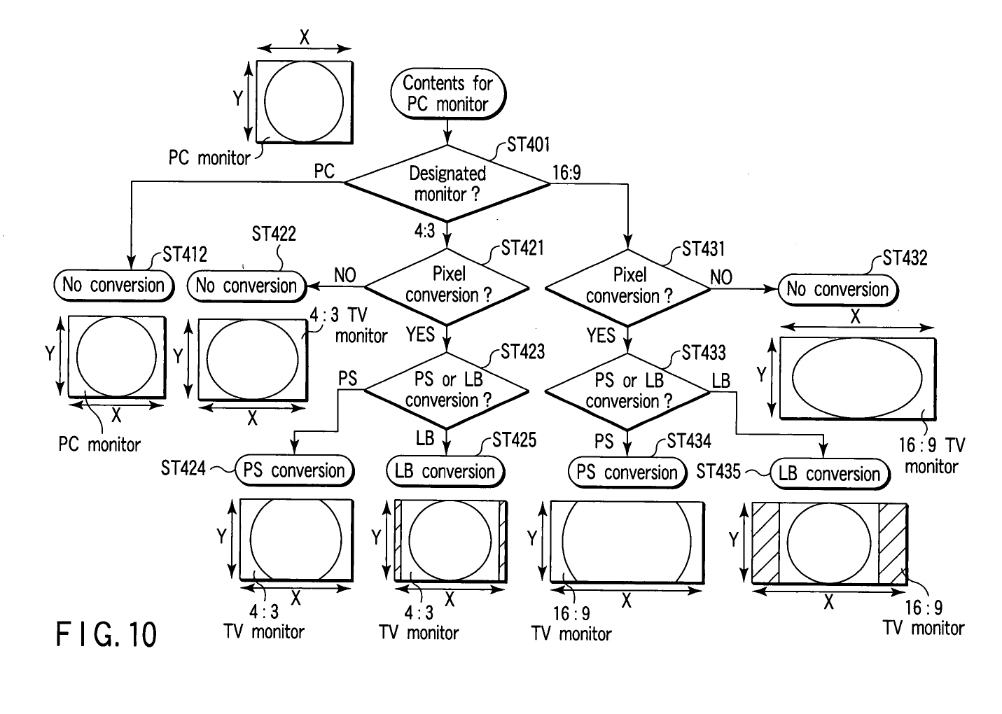

FIG. 10 shows an example of pixel conversion executed when contents for the PC monitor are to be displayed on the 4:3 TV monitor, 16:9 TV monitor, and PC monitor.

The respective pixel converters (still picture pixel converter 203a, animation/moving picture pixel converter 203b, font pixel converter 203c, background picture pixel converter 203d) receive image data and image information (indicating one of “4:3 TV monitor”, “16:9 TV monitor”, and “PC monitor” for which that picture is designed) from the corresponding decoders (still picture decoder 2081a, animation/moving picture decoder 2081b, font decoder 2081c, background picture decoder 2081d), and recognize that the image data are designed for the PC monitor. Note that information indicating a monitor on which the image data is to be displayed can be described in an ENAV document in place of image data itself.

The designated monitor is determined with reference to the current display mode of the video player configuration (P_CFG) (ST401). That is, “monitor information” which is transferred from the ENAV interface to each pixel converter is referred to. At this time, if the designated monitor is a PC monitor, since the monitor on which the contents are to be displayed matches the monitor which is designated to display, no pixel conversion is required (ST412).

If the designated monitor is a 4:3 TV monitor, it is checked based on the description of the ENAV document, i.e., conversion control sent from the XHTML/CSS layout manager 207 to the respective pixel converters if pixel conversion is to be executed (ST421). If no pixel conversion is to be executed, (ST421, NO), the contents are output without any conversion (ST422). In this case, contents are displayed to be slightly horizontally elongated compared to the intended ones. If pixel conversion is to be executed (ST421, YES), LB or PS conversion is executed in accordance with the description of the ENAV document (conversion control from the XHTML/CSS layout manager 207) (ST423, ST424, ST425). As a result of LB conversion in this case, non-display areas are formed on the right and left ends of the display area. Also, as a result of PS conversion in this case, the upper and lower portions of the original contents are not displayed.

If the designated monitor is a 16:9 TV monitor, it is checked based on the description of the ENAV document, i.e., conversion control sent from the XHTML/CSS layout manager 207 to the respective pixel converters if pixel conversion is to be executed (ST431). If no pixel conversion is to be executed, (ST431, NO), the contents are output without any conversion (ST432). In this case, contents are displayed to be horizontally elongated compared to the intended ones. If pixel conversion is to be executed (ST431, YES), LB or PS conversion is executed in accordance with the description of the ENAV document (conversion control from the XHTML/CSS layout manager 207) (ST433, ST434, ST435). As a result of LB conversion in this case, non-display areas are formed on the right and left ends of the display area. Also, as a result of PS conversion in this case, the upper and lower portions of the original contents are not displayed.

FIG. 11 shows a display example of DVD-Video contents and ENAV contents on a 16:9 TV monitor using the aforementioned pixel conversion function. For example, assume that contents designed for a 16:9 TV monitor are prepared as DVD-Video contents, and background picture data designed for a 16:9 TV monitor, still picture data designed for a 4:3 TV monitor, and font data designed for a PC monitor are prepared as ENAV contents.

As for the DVD-Video contents, since the monitor “16:9 TV monitor” on which the contents are designed to be displayed matches the monitor “16:9 TV monitor” which is actually designated to display, pixel conversion is skipped, and the DVD-Video contents undergo resizing (in this case, reduced-scale display) designated by the ENAV document.

Likewise, as for the background picture data, since the monitor on which the background picture data is designed to be displayed matches the monitor which is actually designated to display, pixel conversion is skipped, and the background picture data undergoes resizing designated by the ENAV document.

As for the still picture data, since the monitor “4:3 TV monitor” on which the contents are designed to be displayed matches the monitor “16:9 TV monitor”, the still picture data undergoes conversion shown in FIG. 8. In this example, the ENAV document designates that “LB conversion is executed as pixel conversion”. Furthermore, the still picture data undergoes resizing designated by the ENAV document.

As for the font data, since the monitor “PC monitor” on which the contents are designed to be displayed matches the monitor “16:9 TV monitor”, the font data undergoes conversion shown in FIG. 10. In this example, the ENAV document designates that “no pixel conversion is made”. Also, the ENAV document designates the font size to be displayed, and if font data of that size is prepared, no resizing is required.

As described above, even when the DVD-Video contents and respective ENAV contents are designed to be displayed on different types of monitors, appropriate display can be attained by executing pixel conversion designated by the ENAV document. In this way, even contents which are created by the contents provider to form a site on the Internet, i.e., contents for PC can be diverted to ENAV contents to be recorded on an enhanced DVD disk or server unit.

A method of displaying contents, which are designed to be displayed on a given monitor, on a different monitor in accordance with an instruction of the ENAV document will be described below. In the following description, a case will be exemplified below wherein an ENAV page (FIG. 11: made up of the DVD-Video contents and ENAV contents (still picture, font, and background picture)) which is designed to be displayed on the 16:9 TV monitor above is displayed on a 4:3 TV monitor.

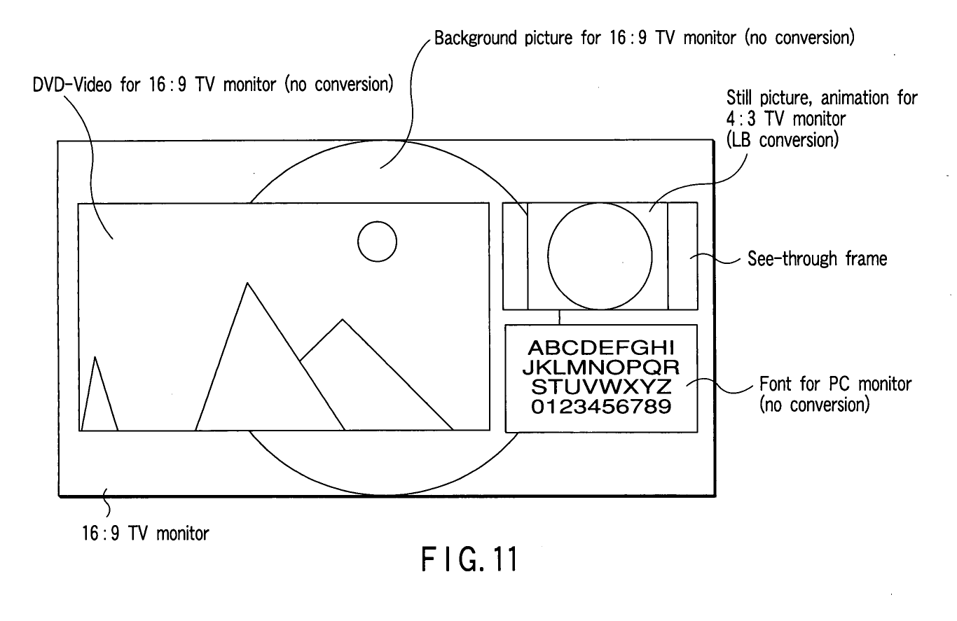

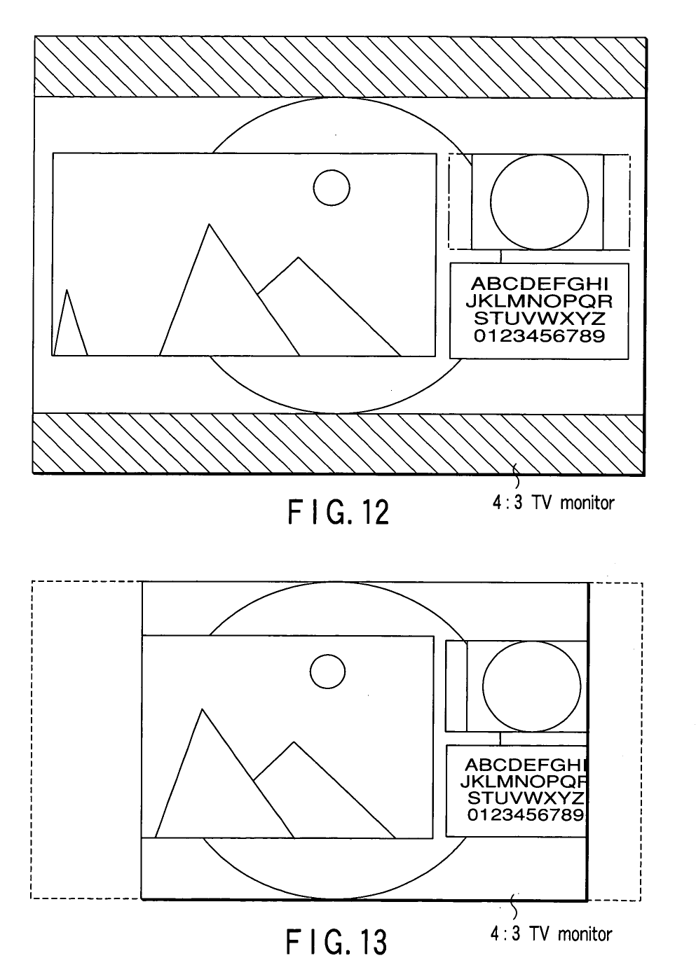

FIG. 12 shows an example wherein the ENAV page (FIG. 11) which is designed to be displayed on the 16 9 monitor undergoes letter box conversion by the D/A converter & LB/PS converter 203m in accordance with an instruction of the ENAV document, i.e., the conversion control from the XHTML/CSS layout manager 307, and is then output onto the 4:3 TV monitor. As a result of this letter box conversion, non-display areas are formed on the upper and lower ends of the monitor screen.

FIG. 13 shows an example wherein the ENAV page (FIG. 11) which is designed to be displayed on the 16:9 monitor undergoes pan scan conversion by the D/A converter & LB/PS converter 203m in accordance with an instruction of the ENAV document, i.e., the conversion control from the XHTML/CSS layout manager 307, and is then output onto the 4:3 TV monitor. In this case, the right and left end portions of the ENAV page are not displayed. For example, these non-display areas and display areas can be designated as needed by the ENAV document, and can also be changed as needed by a user event issued by a user's operation.

Note that the letter box conversion and pan scan conversion shown in FIGS. 12 and 13 can be designated as needed by the ENAV document, and can also be switched as needed by a user event issued by a user's operation.

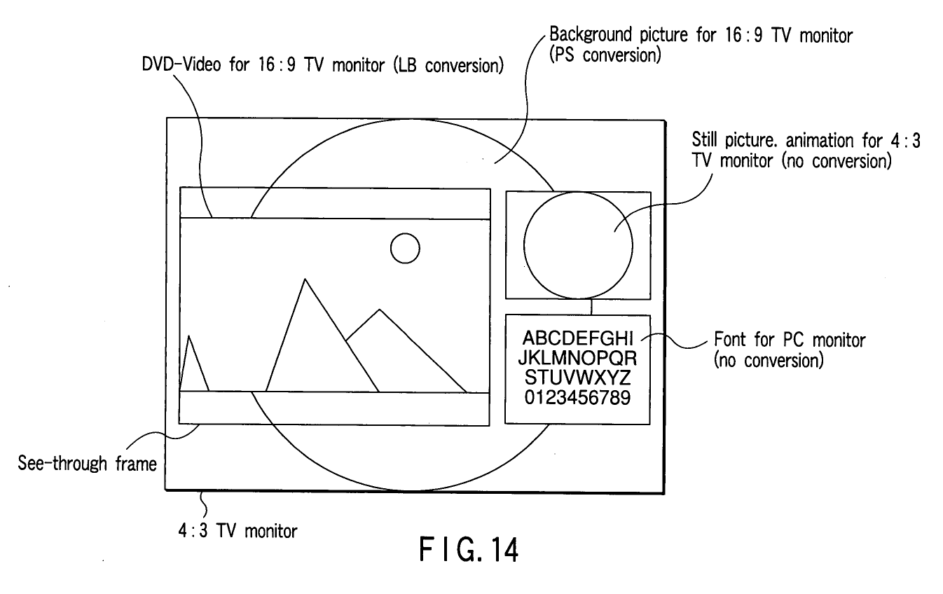

However, in FIG. 12, the actually displayed area is smaller than the area of the 4:3 TV monitor, i.e., non-display areas are formed on the TV monitor. In FIG. 13, given portions of the ENAV page are not displayed on the 4:3 TV monitor. To solve such problems, FIG. 14 shows an example wherein DVD-Video contents and ENAV contents (still picture, font, and background picture), which are the same as those used to display the ENAV page in FIG. 11, are displayed in accordance with an instruction of the ENAV document. Note that this conversion can be implemented as a function of the playback apparatus even when no instruction of the ENAV document is available.

DVD-Video contents for a 16:9 TV monitor undergo letter box conversion. Also, background picture data for a 16:9 TV monitor undergoes pan scan conversion that cuts off the right and left ends of the background picture. Since still picture data for a 4:3 TV monitor is originally designed to be displayed on the 4:3 TV monitor, conversion is skipped. Also, conversion of font data for a PC monitor is skipped.

In this example, although a layout is slightly different from the page for the 16:9 TV monitor shown in FIG. 11, fonts are easier to read than FIG. 12, and the still and background pictures are displayed in a larger scale. Also, non-display areas can be reduced compared to FIG. 13.

In this example, the size after resizing and the font size used in display are the same as those in FIG. 11. That is, the playback apparatus can automatically apply the contents for the 16:9 TV monitor shown in FIG. 11 on the basis of image information of the DVD-Video contents and ENAV contents (still picture, font, and background picture), and can display the page shown in FIG. 14 on the 4:3 TV monitor.

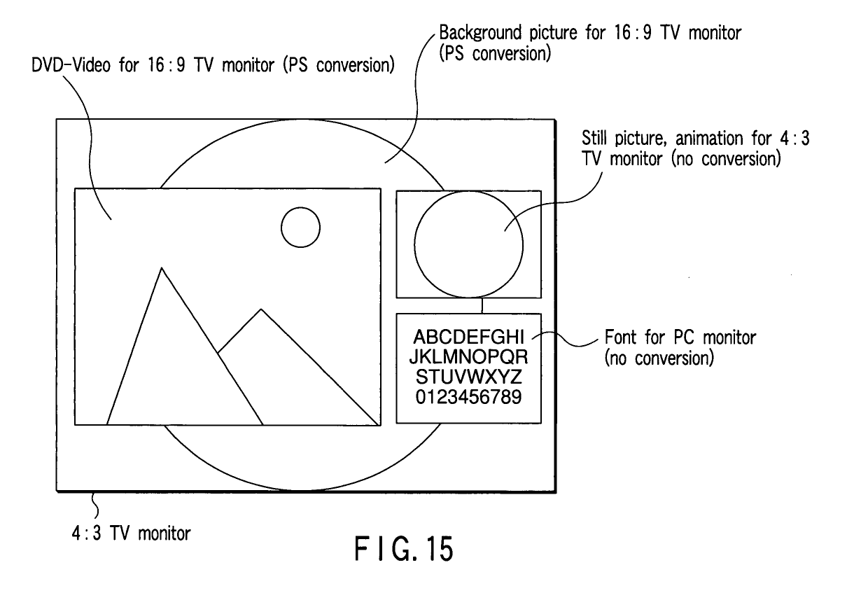

FIG. 15 shows another example upon displaying the contents for the 16:9 TV monitor shown in FIG. 11 on a 4:3 TV monitor. In this case, DVD-Video contents for a 16:9 TV monitor undergo pan scan conversion. Also, background picture data for a 16:9 TV monitor undergoes pan scan conversion that cuts off the right and left ends of the background picture. Since still picture data for a 4:3 TV monitor is originally designed to be displayed on the 4:3 TV monitor, conversion is skipped. Also, conversion of font data for a PC monitor is skipped.

Note that the letter box conversion and pan scan conversion of the DVD-Video contents shown in FIGS. 14 and 15 can be designated as needed by the ENAV document, and can also be switched as needed by a user event issued by a user's operation.

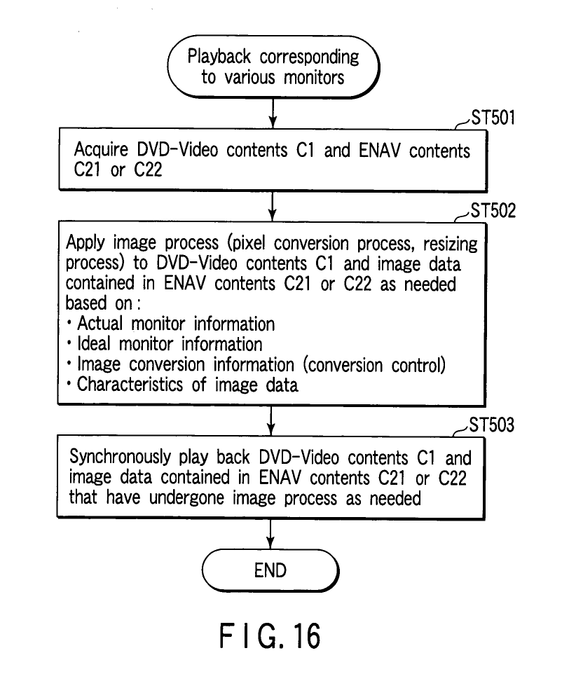

An overview of the present invention will be described below with reference to the flow chart shown in FIG. 16. DVD-Video contents C1 are acquired from an enhanced DVD-Video disk D2, and ENAV contents C21 or C22 are acquired from at least one of the enhanced DVD-Video disk D2 and external server unit 500 (ST501). The DVD-Video contents C1 and image data contained in ENAV contents C21 or C22 undergo image processes as needed on the basis of actual monitor information, optimal monitor information, image conversion information (conversion control), and the characteristics of image data (those of still picture, moving picture, animation, font, background, and the like) (ST502). Note that the image processes include the aforementioned pixel conversion process and resizing process. The DVD-Video contents C1 and ENAV contents C21 or C22 that have undergone the image processes are synchronously played back (ST503). As a result, the image data which have undergone the image processes are appropriately output to a predetermined monitor. In this way, contents can be displayed on the designated monitor by the intended display method.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information playback apparatus comprising:
a first acquisition unit configured to acquire contents from an information storage medium;
a second acquisition unit configured to acquire expansion information from at least one of the information storage medium and an external apparatus via a communication line;
an image processing unit configured to process the contents and image data contained in the expansion information as needed on the basis of actual monitor information indicating an actual output destination of the contents and the expansion information; and
a playback unit configured to play back the contents, and to play back image data, which is contained in the expansion information and has undergone the image process as needed, in synchronism with playback of the contents.

2. An apparatus according to claim 1, wherein the image processing unit comprises:
a pixel conversion unit configured to convert pixels which form the image data contained in the expansion information; and
a size conversion unit configured to convert a size of the image data contained in the expansion information.

3. An apparatus according to claim 1, wherein the image processing unit processes image data contained in the expansion information as needed on the basis of characteristics of that image data or an instruction contained in the expansion information.

4. An apparatus according to claim 1, wherein the expansion information contains optimal monitor information that indicates an optimal output destination of image data contained in that expansion information, and
the image processing unit processes image data contained in the expansion information as needed on the basis of the actual monitor information and the optimal monitor information.

5. An apparatus according to claim 4, wherein the expansion information contains image conversion information that instructs predetermined image conversion when a monitor designated by the actual monitor information is different from a monitor designated by the optimal monitor information, and
the image processing unit processes image data contained in the expansion information as needed on the basis of the actual monitor information, the optimal monitor information, and the image conversion information.

6. An information playback method comprising:
acquiring expansion information from at least one of an information storage medium and an external apparatus via a communication line;
processing contents acquired from the information storage medium and image data contained in the expansion information as needed on the basis of actual monitor information indicating an actual output destination of the contents and the expansion information; and
playing back the contents, and playing back image data, which is contained in the expansion information and has undergone the image process as needed, in synchronism with playback of the contents.

7. A method according to claim 6, wherein the image data process includes at least one of a pixel conversion process that converts pixels which form the image data contained in the expansion information, and a size conversion process that converts a size of the image data contained in the expansion information.

8. A method according to claim 6, wherein image data contained in the expansion information is processed as needed on the basis of characteristics of that image data or an instruction contained in the expansion information.

9. A method according to claim 6, wherein the expansion information contains optimal monitor information that indicates an optimal output destination of image data contained in that expansion information, and
image data contained in the expansion information is processed as needed on the basis of the actual monitor information and the optimal monitor information.

10. A method according to claim 9, wherein the expansion information contains image conversion information that instructs predetermined image conversion when a monitor designated by the actual monitor information is different from a monitor designated by the optimal monitor information, and
image data contained in the expansion information is processed as needed on the basis of the actual monitor information, the optimal monitor information, and the image conversion information.

11. An information playback apparatus comprising:
a first acquisition unit configured to acquire contents from an information storage medium;
a second acquisition unit configured to acquire expansion information from an external apparatus via a communication line;
an image processing unit configured to apply a conversion process to the contents and image data contained in the expansion information on the basis of actual monitor information indicating an actual output destination of the contents and the expansion information, and optimal monitor information which indicates an optimal output destination of the image data contained in the expansion information, and is contained in the expansion information; and
a playback unit configured to play back the contents in accordance with the conversion process of the image processing unit, and to play back image data in the expansion information in synchronism with playback of the contents.
